(19) United States
(12) Patent Application Publication
(10) Pub. No.: US 2018/0049943 A1
(43) Pub. Date: Feb. 22, 2018

(54) THERAPEUTIC TREATMENT FOR INCREASING TESTOSTERONE

(71) Applicant: John Warlick, Woodstock, GA (US)

(72) Inventor: John Warlick, Woodstock, GA (US)

(21) Appl. No.: 15/239,323

(22) Filed: Aug. 17, 2016

(51) Int. Cl. A61H 23/00; A61H 19/00

(52) U.S. Cl. CPC A61H 23/008; A61H 19/30

(57) ABSTRACT

The method of treatment for increasing testosterone levels of an adult male patient is disclosed. The treatment has the steps of activating an acoustic shock wave generator or source to emit acoustic shock waves; and subjecting a testicle through the scrotum to the acoustic shock waves stimulating said testicle wherein the testicle is positioned within a path of the emitted shock waves. The emitted shock waves can be convergent, divergent, planar or near planar.

### FIELD OF THE INVENTION

The invention relates to treatments for increasing testosterone in adult males, more particularly accomplishing this in the absence of pharmaceutical or chemical stimulation.

### BACKGROUND OF THE INVENTION

Testosterone is a steroid hormone from the androgen group and is found in humans and other vertebrates. In humans and other mammals, testosterone is secreted primarily by the testicles of males and, to a lesser extent, the ovaries of females. Small amounts are also secreted by the adrenal glands. It is the principal male sex hormone and an anabolic steroid.

In men, testosterone plays a key role in the development of male reproductive tissues such as the testis and prostate, as well as promoting secondary sexual characteristics such as increased muscle and bone mass, and the growth of body hair. In addition, testosterone is essential for health and well-being, and for the prevention of osteoporosis.

On average, in adult males, levels of testosterone are about 7-8 times as great as in adult females. As the metabolic consumption of testosterone in males is greater, the daily production is about 20 times greater in men. Females are also more sensitive to the hormone.

Testosterone is on the World Health Organization Model List of Essential Medicines, one of the most important medications needed in a basic health system.

In general, androgens such as testosterone promote protein synthesis and thus growth of tissues with androgen receptors. Testosterone can be described as having virilising and anabolic effects though these categorical descriptions are somewhat arbitrary, as there is a great deal of mutual overlap between them.

Anabolic effects include growth of muscle mass and strength, increased bone density and strength, and stimulation of linear growth and bone maturation.

Androgenic effects include maturation of the sex organs, particularly the penis and the formation of the scrotum in the fetus, and after birth typically at puberty a deepening of the voice, growth of facial hair, such as the beard, and underarm and pubic hair. Many of these fall into the category of male secondary sex characteristics.

Testosterone effects can also be classified by the age of usual occurrence. For postnatal effects in both males and females, these are mostly dependent on the levels and duration of circulating free testosterone.

Adult testosterone effects are more clearly demonstrable in males than in females, but are likely important to both sexes. Some of these effects may decline as testosterone levels decrease in the later decades of adult life.

The literature suggests that attention, memory, and spatial ability are key cognitive functions affected by testosterone in humans. Preliminary evidence suggests that low testosterone levels may be a risk factor for cognitive decline and possibly for dementia of the Alzheimer's type, a key argument in life extension medicine for the use of testosterone in anti-aging therapies. Much of the literature, however, suggests a curvilinear or even quadratic relationship between spatial performance and circulating testosterone, where both hypo- and hypersecretion (deficient- and excessive-secretion) of circulating androgens have negative effects on cognition.

The primary use of testosterone is the treatment of males with too little or no natural testosterone production—males with hypogonadism. This is known as hormone replacement therapy or testosterone replacement therapy (TRT), which maintains serum testosterone levels in the normal range. Decline of testosterone production with age has led to interest in androgen replacement therapy.
Testosterone levels decline gradually with age. The Food and Drug Administration (FDA) stated in 2015 that neither the benefits nor the safety of testosterone have been established for low testosterone levels due to aging. The FDA has required that labels on testosterone include warnings about increased risk of heart attacks and stroke.

Testosterone insufficiency, also termed hypotestosteronism or hypotestosteronemia, is an abnormally low testosterone production. It may occur because of testicular dysfunction, primary hypogonadism, or hypothalamic-pituitary dysfunction, secondary hypogonadism, and may be congenital or acquired.

Testosterone therapy may improve the management of type 2 diabetes. Low testosterone has been associated with the development of Alzheimer's disease.

Testosterone is used as a form of doping among athletes in order to improve performance. Testosterone is classified as an anabolic agent and is on the World Anti-Doping Agency (WADA) List of Prohibited Substances and Methods. Several application methods for testosterone, including intramuscular injections, transdermal gels and patches, and implantable pellets. Hormone supplements cause the endocrine system to adjust its production and lower the natural production of the hormone, so when supplements are discontinued, natural hormone production is lower than it was originally. This is known as the Farquharson phenomenon.

Anabolic steroids, including testosterone, have also been taken to enhance muscle development, strength, or endurance. They do so directly by increasing the muscles' protein synthesis. As a result, muscle fibers become larger and repair faster than the average person's.

After a series of scandals and publicity in the 1980s, prohibitions of anabolic steroid use were renewed or strengthened by many sports organizations. Testosterone and other anabolic steroids were designated a “controlled substance” by the United States Congress in 1990, with the Anabolic Steroid Control Act. Their use is seen as a seriously problematic issue in modern sport, particularly given the lengths to which athletes and professional laboratories go to in trying to conceal such use from sports regulators.

A number of methods for detecting testosterone use by athletes have been employed, most based on a urine test. These include the testosterone/epitestosterone ratio (normally less than 6), the testosterone/luteinizing hormone ratio and the carbon-13/carbon-12 ratio (pharmaceutical testosterone contains less carbon-13 than endogenous testosterone). In some testing programs, an individual's own historical results may serve as a reference interval for interpretation of a suspicious finding. Another approach being investigated is the detection of the administered form of testosterone, usually an ester, in hair.

Other significant adverse effects of testosterone supplementation include acceleration of pre-existing prostate cancer growth in individuals who have undergone androgen deprivation; increased hematocrit, which can require venipuncture in order to treat; and, exacerbation of sleep apnea. Adverse effects may also include minor side-effects such as acne and oily skin, as well as, significant hair loss and/or thinning of the hair, which may be prevented with 5-alpha reductase inhibitors ordinarily used for the treatment of benign prostatic hyperplasia, such as finasteride or dutasteride. Exogenous testosterone may also cause suppression of spermatogenesis, leading to, in some cases, infertility. It is recommended that physicians screen for prostate cancer with a digital rectal exam and prostate-specific antigen (PSA) level before starting therapy, and monitor PSA and hematocrit levels closely during therapy.

The chemical synthesis of testosterone from cholesterol was achieved by Butenandt and Hanisch. A week later, the Ciba group in Zurich, Leopold Ruzicka (1887-1976) and A. Wettstein, published their synthesis of testosterone. Ruzicka L, Wettstein A (1935). “Uber die kristallinische Herstellung des Testikelhormons, Testosteron (Androsten-3-ol-17-ol) [The crystalline production of the testicle hormone, testosterone (Androsten-3-ol-17-ol)]”. Helvetica Chimica Acta (in German). 18: 1264-75. These independent partial syntheses of testosterone from a cholesterol base earned both Butenandt and Ruzicka the joint 1939 Nobel Prize in Chemistry. Testosterone was identified as 17β-hydroxyandrost-4-en-3-one (C19H28O2), a solid polycyclic alcohol with a hydroxyl group at the 17th carbon atom. This also made it obvious that additional modifications on the synthesized testosterone could be made, i.e., esterification and alkylation.

The partial synthesis in the 1930s of abundant, potent testosterone esters permitted the characterization of the hormone's effects, so that Kochakian and Murlin (1936) were able to show that testosterone raised nitrogen retention (a mechanism central to anabolism) in dogs, after which Allan Kenyon's group was able to demonstrate both anabolic and androgenic effects of testosterone propionate in eunuchoidal men, boys, and women. The period of the early 1930s to the 1950s has been called “The Golden Age of Steroid Chemistry”, and work during this period progressed quickly. Research in this golden age proved that this newly synthesized compound—testosterone—or rather family of compounds (for many derivatives were developed from 1940 to 1960), was a potent multiplier of muscle, strength, and well-being.

The present invention avoids synthetic or chemical injections and provides a unique way to increase testosterone levels in the absence of drugs.

### SUMMARY OF INVENTION

The method of treatment for increasing testosterone levels in adult male patients is disclosed. The treatment has the steps of activating an acoustic shock wave generator or source to emit acoustic shock waves; and subjecting the a testicle through the scrotum to the acoustic shock waves stimulating said testicle wherein the testicle is positioned within a path of the emitted shock waves. The emitted shock waves can be convergent, divergent, planar or near planar.

In one method of treatment, the emitted shock waves are convergent having one or more geometric focal volumes of points at a distance of at least X from the generator or source. The method positions the testicle at a distance at or less than the distance X from the source.

The method of treatment can involve testing the testosterone level of the male patient after exposure to one or more acoustic shock wave treatments.

### Definitions

A “curved emitter” is an emitter having a curved reflecting (or focusing) or emitting surface and includes, but is not limited to, emitters having ellipsoidal, parabolic, quasi parabolic (general paraboloid) or spherical reflector/reflecting or emitting elements. Curved emitters having a curved reflecting or focusing element generally produce waves having focused wave fronts, while curved emitters having a curved emitting surfaces generally produce wave having divergent wave fronts.

“Divergent waves” in the context of the present invention are all waves which are not focused and are not plane or nearly plane. Divergent waves also include waves which only seem to have a focus or source from which the waves are transmitted. The wave fronts of divergent waves have divergent characteristics. Divergent waves can be created in many different ways, for example: A focused wave will become divergent once it has passed through the focal point. Spherical waves are also included in this definition of divergent waves and have wave fronts with divergent characteristics.

“extracorporeal” occurring or based outside the living body.

A “generalized paraboloid” according to the present invention is also a three-dimensional bowl. In two dimensions (in Cartesian coordinates, x and y) the formula yⁿ=2px [with n being≠2, but being greater than about 1.2 and smaller than 2, or greater than 2 but smaller than about 2.8]. In a generalized paraboloid, the characteristics of the wave fronts created by electrodes located within the generalized paraboloid may be corrected by the selection of (p (−z,+z)), with z being a measure for the burn down of an electrode, and n, so that phenomena including, but not limited to, burn down of the tip of an electrode (−z,+z) and/or disturbances caused by diffraction at the aperture of the paraboloid are compensated for.

“hormone imbalance” an increase in the oestrogen, progesterone ratio that is the main cause of anxiety, tension and irritability.

“impotence” an abnormal physical or psychological state of a male characterized by inability to copulate because of failure to have or maintain an erection—called also erectile dysfunction. In females it means a loss of sensation in the vaginal region and a resultant psychological lack of desire for sexual contact.

A “paraboloid” according to the present invention is a three-dimensional reflecting bowl. In two dimensions (in Cartesian coordinates, x and y) the formula y²=2px, wherein p/2 is the distance of the focal point of the paraboloid from its apex, defines the paraboloid. Rotation of the two-dimensional figure defined by this formula around its longitudinal axis generates a de facto paraboloid.

“Plane waves” are sometimes also called flat or even waves. Their wave fronts have plane characteristics (also called even or parallel characteristics). The amplitude in a wave front is constant and the “curvature” is flat (that is why these waves are sometimes called flat waves). Plane waves do not have a focus to which their fronts move (focused) or from which the fronts are emitted (divergent). “Nearly plane waves” also do not have a focus to which their fronts move (focused) or from which the fronts are emitted (divergent). The amplitude of their wave fronts (having “nearly plane” characteristics) is approximating the constancy of plain waves. “Nearly plane” waves can be emitted by generators having pressure pulse/shock wave generating elements with flat emitters or curved emitters. Curved emitters may comprise a generalized paraboloid that allows waves having nearly plane characteristics to be emitted.

A “pressure pulse” according to the present invention is an acoustic pulse which includes several cycles of positive and negative pressure. The amplitude of the positive part of such a cycle should be above about 0.1 MPa and its time duration is from below a microsecond to about a second. Rise times of the positive part of the first pressure cycle may be in the range of nano-seconds (ns) up to some milli-seconds (ms). Very fast pressure pulses are called shock waves. Shock waves used in medical applications do have amplitudes above 0.1 MPa and rise times of the amplitude are below 100 ns. The duration of a shock wave is typically below 1-3 micro-seconds (μs) for the positive part of a cycle and typically above some micro-seconds for the negative part of a cycle.

Waves/wave fronts described as being “focused” or “having focusing characteristics” means in the context of the present invention that the respective waves or wave fronts are traveling and increase their amplitude in direction of the focal point. Per definition the energy of the wave will be at a maximum in the focal point or, if there is a focal shift in this point, the energy is at a maximum near the geometrical focal point. Both the maximum energy and the maximal pressure amplitude may be used to define the focal point.

### BRIEF DESCRIPTION OF THE DRAWINGS

The invention will be described by way of example and with reference to the accompanying drawings in which:

FIG. 1a is a simplified depiction of a pressure pulse/shock wave (PP/SW) generator with focusing wave characteristics.

FIG. 1b is a simplified depiction of a pressure pulse/shock wave generator with plane wave characteristics.

FIG. 1c is a simplified depiction of a pressure pulse/shock wave generator with divergent wave characteristics.

FIG. 2a is a simplified depiction of a pressure pulse/shock wave generator having an adjustable exit window along the pressure wave path. The exit window is shown in a focusing position.

FIG. 2b is a simplified depiction of a pressure pulse/shock wave generator having an exit window along the pressure wave path. The exit window as shown is positioned at the highest energy divergent position.

FIG. 2c is a simplified depiction of a pressure pulse/shock wave generator having an exit window along the pressure wave path. The exit window is shown at a low energy divergent position.

FIG. 3 is a simplified depiction of an electro-hydraulic pressure pulse/shock wave generator having no reflector or focusing element. Thus, the waves of the generator did not pass through a focusing element prior to exiting it.

FIG. 4a is a simplified depiction of a pressure pulse/shock wave generator having a focusing element in the form of an ellipsoid. The waves generated are focused.

FIG. 4b is a simplified depiction of a pressure pulse/shock wave generator having a parabolic reflector element and generating waves that are disturbed plane.

FIG. 4c is a simplified depiction of a pressure pulse/shock wave generator having a quasi parabolic reflector element (generalized paraboloid) and generating waves that are nearly plane/have nearly plane characteristics.

FIG. 4d is a simplified depiction of a generalized paraboloid with better focusing characteristic than a paraboloid in which n=2. The electrode usage is shown. The generalized paraboloid, which is an interpolation (optimization) between two optimized paraboloids for a new electrode and for a used (burned down) electrode is also shown.

FIG. 5 is a simplified depiction of a pressure pulse/shock wave generator being connected to a control/power supply unit.

FIG. 6 is a simplified depiction of a pressure pulse/shock wave generator comprising a flat EMSE (electromagnetic shock wave emitter) coil system to generate nearly plane waves as well as an acoustic lens. Convergent wave fronts are leaving the housing via an exit window.

FIG. 7 is a simplified depiction of a pressure pulse/shock wave generator having a flat EMSE coil system to generate nearly plane waves. The generator has no reflecting or focusing element. As a result, the pressure pulse/shock waves are leaving the housing via the exit window unfocused having nearly plane wave characteristics.

FIG. 8 is a simplified depiction of a pressure pulse/shock wave generator having a flat piezoceramic plate equipped with a single or numerous individual piezoceramic elements to generate plane waves without a reflecting or focusing element. As a result, the pressure pulse/shock waves are leaving the housing via the exit window unfocused having nearly plane wave characteristics.

FIG. 9 is a simplified depiction of a pressure pulse/shock wave generator having a cylindrical EMSE system and a triangular shaped reflecting element to generate plane waves. As a result, the pressure pulse/shock waves are leaving the housing via the exit window unfocused having nearly plane wave characteristics.

FIG. 10 is a simplified depiction of a pressure pulse/shock wave (PP/SW) generator with focusing wave characteristics shown focused with the focal point or geometrical focal volume being on an organ, the focus being targeted on the location X₀.

FIG. 11 is a simplified depiction of a pressure pulse/shock wave (PP/SW) generator with the focusing wave characteristics shown wherein the focus is located a distance X, from the location X₀ of an organ wherein the converging waves impinge the organ.

FIG. 12 is a simplified depiction of a pressure pulse/shock wave (PP/SW) generator with focusing wave characteristics shown wherein the focus is located a distance X₂ from the mass location X₀ wherein the emitted divergent waves impinge the organ.

### DETAILED DESCRIPTION OF THE INVENTION

Like other steroid hormones, testosterone is derived from cholesterol. The first step in the biosynthesis involves the oxidative cleavage of the sidechain of cholesterol by CYP11A, a mitochondrial cytochrome P450 oxidase with the loss of six carbon atoms to give pregnenolone. In the next step, two additional carbon atoms are removed by the CYP17A enzyme in the endoplasmic reticulum to yield a variety of C19 steroids. In addition, the 3-hydroxyl group is oxidized by 3-β-HSD to produce androstenedione. In the final and rate limiting step, the C-17 keto group androstenedione is reduced by 17-β hydroxysteroid dehydrogenase to yield testosterone.

The largest amounts of testosterone (>95%) are produced by the testes in men. It is also synthesized in far smaller quantities in women by the thecal cells of the ovaries, by the placenta, as well as by the zona reticularis of the adrenal cortex and even skin in both sexes. In the testes, testosterone is produced by the Leydig cells. The male generative glands also contain Sertoli cells, which require testosterone for spermatogenesis. Like most hormones, testosterone is supplied to target tissues in the blood where much of it is transported bound to a specific plasma protein, sex hormone-binding globulin (SHBG).

In males, testosterone is synthesized primarily in Leydig cells. The number of Leydig cells in turn is regulated by luteinizing hormone (LH) and follicle-stimulating hormone (FSH). In addition, the amount of testosterone produced by existing Leydig cells is under the control of LH, which regulates the expression of 17-β hydroxysteroid dehydrogenase.

The amount of testosterone synthesized is regulated by the hypothalamic—pituitary—testicular axis. When testosterone levels are low, gonadotropin-releasing hormone (GnRH) is released by the hypothalamus, which in turn stimulates the pituitary gland to release FSH and LH. These latter two hormones stimulate the testis to synthesize testosterone. Finally, increasing levels of testosterone through a negative feedback loop act on the hypothalamus and pituitary to inhibit the release of GnRH and FSH/LH, respectively.

98% of testosterone in plasma is bound to protein. 65% is bound to beta-globulin called Gonadal steroid-binding globulin (GBG) or Sex steroid-binding globulin and 33% to albumin Plasma testosterone level in the body (free or bound): 10.4-24.3 nmol/L) in adult men. In women: 30-70 ng/dL. A small amount of circulating testosterone is converted to estradiol, but most of the testosterone is converted to 17-ketosteroids, principally androsterone and its isomer etio-cholanolone, and excreted in urine.

Approximately 7% of testosterone is reduced to 5α-dihydrotestosterone (DHT) by the cytochrome P450 enzyme 5α-reductase, an enzyme highly expressed in male sex organs and hair follicles. Approximately 0.3% of testosterone is converted into estradiol by aromatase (CYP19A1) an enzyme expressed in the brain, liver, and adipose tissues.

DHT is a more potent form of testosterone while estradiol has completely different activities (feminization) compared to testosterone (masculinization). Also, testosterone and DHT may be deactivated or cleared by enzymes that hydroxylate at the 6, 7, 15 or 16 positions.

The effects of testosterone in humans and other vertebrates occur by way of multiple mechanisms: by activation of the androgen receptor (directly or as DHT), and by conversion to estradiol and activation of certain estrogen receptors. Androgens such as testosterone have also been found to bind to and activate membrane androgen receptors.

Free testosterone (T) is transported into the cytoplasm of target tissue cells, where it can bind to the androgen receptor, or can be reduced to 5α-dihydrotestosterone (DHT) by the cytoplasmic enzyme 5-alpha reductase. DHT binds to the same androgen receptor even more strongly than testosterone, so that its androgenic potency is about 5 times that of T. The T-receptor or DHT-receptor complex undergoes a structural change that allows it to move into the cell nucleus and bind directly to specific nucleotide sequences of the chromosomal DNA. The areas of binding are called hormone response elements (HREs), and influence transcriptional activity of certain genes, producing the androgen effects.

Androgen receptors occur in many different vertebrate body system tissues, and both males and females respond similarly to similar levels. Greatly differing amounts of testosterone prenatally, at puberty, and throughout life account for a share of biological differences between males and females.

The bones and the brain are two important tissues in humans where the primary effect of testosterone is by way of aromatization to estradiol. In the bones, estradiol accelerates ossification of cartilage into bone, leading to closure of the epiphyses and conclusion of growth. In the central nervous system, testosterone is aromatized to estradiol. Estradiol rather than testosterone serves as the most important feedback signal to the hypothalamus (especially affecting LH secretion). In many mammals, prenatal or perinatal “masculinization” of the sexually dimorphic areas of the brain by estradiol derived from testosterone programs later male sexual behavior.

Prior art solutions have many routes of administration for testosterone. Forms of testosterone for human administration currently available include injectable (such as testosterone cypionate or testosterone enanthate in oil), oral, buccal, transdermal skin patches, transdermal creams, gels, and implantable pellets. Roll-on methods and nasal sprays are currently under development.

The present invention provides a novel, non-invasive treatment therapy for increasing testosterone levels in adult males.

In the area of impotency, the subject or diagnosed patient often loses all interest in sexual activity or if actively interested, is unable to perform. This is most common in males, but can and does occur in females as well.

The reasons for impotency can vary widely, but often the cause can be a physiological disorder relating to insufficient blood flow to and in the region of the reproductive organs or a lack of nerve responsiveness to stimulation in the reproductive tissues.

Similarly the reasons for low testosterone levels can vary widely. This is a very natural response to aging and is not altogether unexpected.

Numerous drugs are now provided to enhance male performance most of which results in an increase in blood flow to achieve the desired results. All of these drugs run the risk of causing a stroke or heart attack. The present invention can be used to regenerate the vascular system locally in the region of the heart or the reproductive system and can achieve the same or similar benefits of increased blood flow on a more continuous basis compared to the temporary response of drugs, but without any of the adverse consequences.

To better appreciate how shock waves work one must gain an appreciation of the apparatus and devices used to generate such wave patterns.

In the shock wave method of treating a tissue, an organ or the entire body of a patient diagnosed with infertility or impotence requires the patient to be positioned in a convenient orientation to permit the source of the emitted waves to most directly send the waves to the target site to initiate shock wave stimulation of the target area with minimal, preferably no obstructing features in the path of the emitting source or lens. Assuming the target area is within a projected area of the wave transmission, a single transmission dosage of wave energy may be used. The transmission dosage can be from a few seconds to 20 minutes or more dependant on the condition. Preferably the waves are generated from an unfocused or focused source. The unfocused waves can be divergent, planar or near planar and having a low pressure amplitude and density in the range of 0.00001 mJ/mm² to 1.0 mJ/mm² or less, most typically below 0.2 mJ/mm². The focused source preferably can use a diffusing lens or have a far-sight focus to minimize if not eliminate having the localized focus point within the tissue. Preferably the focused shock waves are used at a similarly effective low energy transmission or alternatively can be at higher energy but wherein the tissue target site is disposed pre-convergence inward of the geometric focal point of the emitted wave transmission.

These shock wave energy transmissions are effective in stimulating a cellular response and can be accomplished without creating the cavitation bubbles in the tissue of the target site. This effectively insures the tissue or organ does not have to experience the sensation of hemorrhaging so common in the higher energy focused wave forms having a focal point at or within the targeted treatment site.

If the target site is a reproductive tissue or organ subjected to a surgical procedure exposing at least some if not all of the tissue or organ within the body cavity the target site may be such that the patient or the generating source must be reoriented relative to the site and a second, third or more treatment dosage can be administered. The fact that the dosage can be at a low energy the common problem of localized hemorrhaging is reduced making it more practical to administer multiple dosages of waves from various orientations to further optimize the treatment and cellular stimulation of the target site. Heretofore focused high energy multiple treatments induced pain and discomfort to the patient. The use of low energy focused or un-focused waves at the target site enables multiple sequential treatments.

The present method does not rely on precise site location per se, although can be used in combination with such known devices as ultrasound, cat-scan or x-ray imaging if needed. The physician's general understanding of the anatomy of the patient should be sufficient to locate the target area to be treated. This is particularly true when the exposed tissue or portion of the organ is visually within the surgeon's line of sight and this permits the lens or cover of the emitting shock wave source to impinge on the organ or tissue directly or through a transmission enhancing gel, water or fluid cushion medium during the shock wave treatment. The treated area can withstand a far greater number of shock waves based on the selected energy level being emitted. For example at very low energy levels the stimulation exposure can be provided over prolonged periods as much as 20 minutes if so desired. At higher energy levels the treatment duration can be shortened to less than a minute, less than a second if so desired. The limiting factor in the selected treatment dosage is avoidance or minimization of cell hemorrhaging and other kinds of damage to the cells or tissue while still providing a stimulating stem cell activation or a cellular release or activation of VEGF and other growth factors.

Due to the wide range of beneficial treatments available it is believed preferable that the optimal use of one or more wave generators or sources should be selected on the basis of the specific application. Wherein relatively small target sites may involve a single wave generator placed on an adjustable manipulator arm. A key advantage of the present inventive methodology is that it is complimentary to conventional medical procedures. In the case of any operative surgical procedure the surgical area of the patient can be bombarded with these low energy waves to stimulate cellular release of healing agents and growth factors. This will dramatically reduce the healing process time. Most preferably such patients may be provided more than one such treatment with an intervening dwell time for cellular relaxation prior to secondary and tertiary post operative treatments.

The underlying principle of these shock wave therapy methods is to stimulate the body's own natural healing capability. This is accomplished by deploying shock waves to stimulate stem cells in the tissue to activate a variety of responses. The acoustic shock waves transmit or trigger what appears to be a cellular communication throughout the entire anatomical structure, this activates a generalized cellular response at the treatment site, in particular, but more interestingly a systemic response in areas more removed from the wave form pattern. This is believed to be one of the reasons molecular stimulation can be conducted at threshold energies heretofore believed to be well below those commonly accepted as required. Accordingly not only can the energy intensity be reduced but also the number of applied shock wave impulses can be lowered from several thousand to as few as one or more pulses and still yield a beneficial stimulating response.

The use of shock waves as described above appears to involve factors such as thermal heating, light emission, electromagnetic field exposure, chemical releases in the cells as well as a microbiological response within the cells. Which combination of these factors plays a role in stimulating healing is not yet resolved. However, there appears to be a commonality in the fact that growth factors are released which applicants find indicative that otherwise dormant cells within the tissue appear to be activated which leads to the remarkable ability of the targeted organ or tissue to generate new growth or to regenerate weakened vascular networks in for example the reproductive system or the cardio vascular system. This finding leads to a complimentary use of shock wave therapy in combination with stem cell therapies that effectively activate or trigger stem cells to more rapidly replicate enhancing the ability to harvest and culture more viable cells from the placenta, a nutrient culture of said stem cells, or other sources. The ability to stimulate stem cells can occur within the patients own body activating the naturally occurring stem cells or stem cells that have been introduced to the patient as part of a treatment beneficially utilizing stem cells. This is a significant clinical value in its own right and is critical in attempts to overcome conditions of low testosterone.

The use of shock wave therapy requires a fundamental understanding of focused and unfocused shock waves, coupled with a more accurate biological or molecular model.

Focused shock waves are focused using ellipsoidal reflectors in electromechanical sources from a cylindrical surface or by the use of concave or convex lenses. Piezoelectric sources often use spherical surfaces to emit acoustic pressure waves which are self focused and have also been used in spherical electromagnetic devices.

The biological model proposed by co-inventor Wolfgang Schaden provides a whole array of clinically significant uses of shock wave therapy.

Accepting the biological model as promoted by W. Schaden, the peak pressure and the energy density of the shock waves can be lowered dramatically. Activation of the body's healing mechanisms will be seen by in growth of new blood vessels and the release of growth factors.

The biological model motivated the design of sources with low pressure amplitudes and energy densities. First: spherical waves generated between two tips of an electrode; and second: nearly even waves generated by generalized parabolic reflectors. Third: divergent shock front characteristics are generated by an ellipsoid behind F2. Unfocused sources are preferably designed for extended two dimensional areas/volumes like skin. The unfocused sources can provide a divergent wave pattern a planar or a nearly planar wave pattern and can be used in isolation or in combination with focused wave patterns yielding to an improved therapeutic treatment capability that is non-invasive with few if any disadvantageous contraindications. Alternatively a focused wave emitting treatment may be used wherein the focal point extends preferably beyond the target treatment site, potentially external to the patient. This results in the reduction of or elimination of a localized intensity zone with associated noticeable pain effect while providing a wide or enlarged treatment volume at a variety of depths more closely associated with high energy focused wave treatment. The utilization of a diffuser type lens or a shifted far-sighted focal point for the ellipsoidal reflector enables the spreading of the wave energy to effectively create a convergent but off target focal point. This insures less tissue trauma while insuring cellular stimulation to enhance the healing process and to effectively remodel the reproductive tissues or organs of the patient.

This method of treatment has the steps of, locating a treatment site, generating either convergent diffused or far-sighted focused shock waves or unfocused shock waves, of directing these shock waves to the treatment site; and applying a sufficient number of these shock waves to induce activation of one or more growth factors thereby inducing or accelerating healing and tissue and organ remodeling or repair.

The unfocused shock waves can be of a divergent wave pattern, planar or near planar pattern preferably of a low peak pressure amplitude and density. Typically the energy density values range as low as 0.000001 mJ/mm² and having a high end energy density of below 1.0 mJ/mm², preferably 0.20 mJ/mm² or less. The peak pressure amplitude of the positive part of the cycle should be above 1.0 and its duration is below 1-3 microseconds.

The treatment depth can vary from the surface to the full depth of the treated organ. The treatment site can be defined by a much larger treatment area than the 0.10-3.0 cm² commonly produced by focused waves. The above methodology is particularly well suited for surface as well as sub-surface soft tissue organ treatments as is found in the regions of the reproductive system, most particularly, in this invention, directly on a testicle through the scrotum.

The above methodology is valuable in generation of tissue, vascularization and may be used in combination with stem cell therapies as well as regeneration of tissue and vascularization.

The methodology is useful in stimulating enforcement of defense mechanisms in tissue cells to fight infections from bacteria and can be used germicidally to treat or cleanse wounds or other reproduction target sites which is a primary concern in the case of treating conditions of infertility.

While the above listed indications cited above are not exhaustive nor intended to be limiting, it is exemplary of the wide range of beneficial uses of low energy and amplitude unfocused divergent, planar or nearly planar shock waves, convergent shock waves, diffused shock waves or a combination of shock wave types in the treatment of adult male humans and other male mammals that are testosterone deficient.

A most significant method of preventive medicine can be practiced that is fully enabled by the use of these relatively low amplitude and pressure shock waves. The method includes the steps of identifying high risk adult male patients for low level testosterone conditions. After identifying a risk prone candidate providing one or a series of two or more exposure treatments with unfocused, divergent, planar or near planar shock waves or convergent far-sighted focused shock waves or diffused shock waves to the treatment site, in this example the region of the testicles in the scrotum. Then after treatments the physician can optionally ultrasound visually or otherwise determine the increase in testosterone levels after a period of time. Assuming an initial baseline determination of the testosterone level had been initially conducted an estimate or calculation of treatment requirements can be made.

The implications of using the (re)generative features of this type of shock wave therapy are any deficiencies in testosterone can be increased to the point of reducing or eliminating the low level risk.

The stimulation of growth factors and activation of healing acceleration within the cells of the treated tissues is particularly valuable to aging patients and other high risk factor subjects.

Even more striking as mentioned earlier, early prevention therapies can be employed to stimulate tissue or organ modeling to be maintained within acceptable TRT ranges prior to an exposure to a degenerative condition occurring. This is extremely valuable in the prevention of age related issue. The methods would be to identify at risk patients or workers based on family history and exposure risks, and subjecting that patient or worker to therapeutic shock wave therapy for the purpose of stimulating tissue repair or regeneration effectively remodeling the patient's TRT levels to be within accepted functional parameters prior to loss. The objective being to preventively stimulate cellular testicular TRT production to preemptively avoid a degenerative condition from occurring which may result in the onset of reproductive disease which may require invasive surgical procedures.

This preventive therapy is most needed to combat age related loss of function which left untreated results in cellular destruction or any other degenerative conditions within the entire reproductive system.

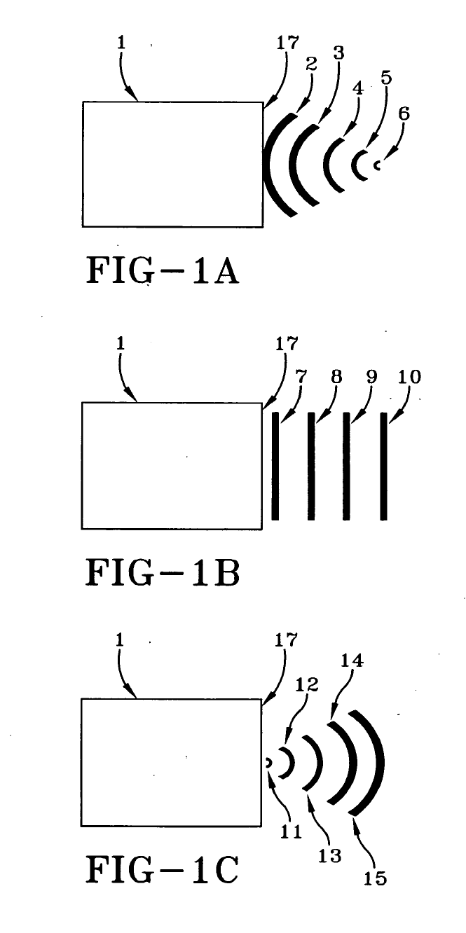

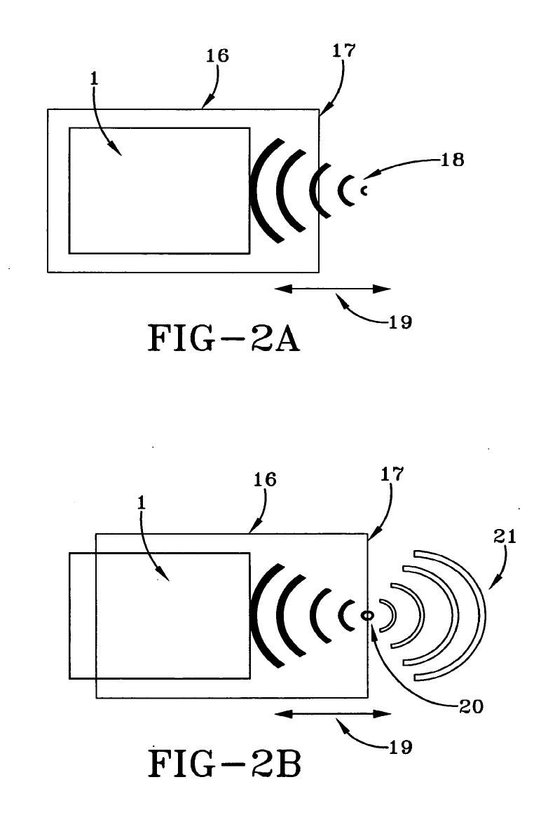

FIG. 1a is a simplified depiction of the a pressure pulse/shock wave (PP/SW) generator, such as a shock wave head, showing focusing characteristics of transmitted acoustic pressure pulses. Numeral 1 indicates the position of a generalized pressure pulse generator, which generates the pressure pulse and, via a focusing element, focuses it outside the housing to treat diseases. The affected tissue or organ is generally located in or near the focal point which is located in or near position 6. At position 17 a water cushion or any other kind of exit window for the acoustical energy is located.

FIG. 1b is a simplified depiction of a pressure pulse/shock wave generator, such as a shock wave head, with plane wave characteristics. Numeral 1 indicates the position of a pressure pulse generator according to the present invention, which generates a pressure pulse which is leaving the housing at the position 17, which may be a water cushion or any other kind of exit window. Somewhat even (also referred to herein as “disturbed”) wave characteristics can be generated, in case a paraboloid is used as a reflecting element, with a point source (e.g. electrode) that is located in the focal point of the paraboloid. The waves will be transmitted into the patient's body via a coupling media such as, e.g., ultrasound gel or oil and their amplitudes will be attenuated with increasing distance from the exit window 17.

FIG. 1c is a simplified depiction of a pressure pulse shock wave generator (shock wave head) with divergent wave characteristics. The divergent wave fronts may be leaving the exit window 17 at point 11 where the amplitude of the wave front is very high. This point 17 could be regarded as the source point for the pressure pulses. In FIG. 1c the pressure pulse source may be a point source, that is, the pressure pulse may be generated by an electrical discharge of an electrode under water between electrode tips. However, the pressure pulse may also be generated, for example, by an explosion, referred to as a ballistic pressure pulse. The divergent characteristics of the wave front may be a consequence of the mechanical setup shown in FIG. 2b.

FIG. 2a is a simplified depiction of a pressure pulse/shock wave generator (shock wave head) according to the present invention having an adjustable or exchangeable (collectively referred to herein as “movable”) housing around the pressure wave path. The apparatus is shown in a focusing position. FIG. 2a is similar to FIG. 1a but depicts an outer housing (16) in which the acoustical pathway (pressure wave path) is located. In a preferred embodiment, this pathway is defined by especially treated water (for example, temperature controlled, conductivity and gas content adjusted water) and is within a water cushion or within a housing having a permeable membrane, which is acoustically favorable for the transmission of the acoustical pulses. In certain embodiments, a complete outer housing (16) around the pressure pulse/shock wave generator (1) may be adjusted by moving this housing (16) in relation to, e.g., the focusing element in the generator. However, as the person skilled in the art will appreciate, this is only one of many embodiments of the present invention. While the figure shows that the exit window (17) may be adjusted by a movement of the complete housing (16) relative to the focusing element, it is clear that a similar, if not the same, effect can be achieved by only moving the exit window, or, in the case of a water cushion, by filling more water in the volume between the focusing element and the cushion. FIG. 2a shows the situation in which the arrangement transmits focused pressure pulses.

FIG. 2b is a simplified depiction of the pressure pulse/shock wave generator (shock wave head) having an adjustable or exchangeable housing around the pressure wave path with the exit window 17 being in the highest energy divergent position. The configuration shown in FIG. 2b can, for example, be generated by moving the housing (16) including the exit window (17), or only the exit window (17) of a water cushion, towards the right (as shown in the Figure) to the second focus f2 (20) of the acoustic waves. In a preferred embodiment, the energy at the exit window will be maximal. Behind the focal point, the waves may be moving with divergent characteristics (21).

FIG. 2c is a simplified depiction of the pressure pulse/shock wave generator (shock wave head) having an adjustable or exchangeable housing around the pressure wave path in a low energy divergent position. The adjustable housing or water cushion is moved or expanded much beyond f2 position (20) so that highly divergent wave fronts with low energy density values are leaving the exit window (17) and may be coupled to a patient's body. Thus, an appropriate adjustment can change the energy density of a wave front without changing its characteristic.

This apparatus may, in certain embodiments, be adjusted/modified/or the complete shock wave head or part of it may be exchanged so that the desired and/or optimal acoustic profile such as one having wave fronts with focused, nearly plane or divergent characteristics can be chosen.

A change of the wave front characteristics may, for example, be achieved by changing the distance of the exit acoustic window relative to the reflector, by changing the reflector geometry, by introducing certain lenses or by removing elements such as lenses that modify the waves produced by a pressure pulse/shock wave generating element. Exemplary pressure pulse/shock wave sources that can, for example, be exchanged for each other to allow an apparatus to generate waves having different wave front characteristics are described in detail below.

In certain embodiments, the change of the distance of the exit acoustic window can be accomplished by a sliding movement. However, in other embodiments of the present invention, in particular, if mechanical complex arrangements, the movement can be an exchange of mechanical elements.

In one embodiment, mechanical elements that are exchanged to achieve a change in wave front characteristics include the primary pressure pulse generating element, the focusing element, the reflecting element, the housing and the membrane. In another embodiment, the mechanical elements further include a closed fluid volume within the housing in which the pressure pulse is formed and transmitted through the exit window.

In one embodiment, the apparatus of the present invention is used in combination therapy. Here, the characteristics of waves emitted by the apparatus are switched from, for example, focused to divergent or from divergent with lower energy density to divergent with higher energy density. Thus, effects of a pressure pulse treatment can be optimized by using waves having different characteristics and/or energy densities, respectively.

While the above described universal toolbox of the present invention provides versatility, the person skilled in the art will appreciate that apparatuses that only produce waves having, for example, nearly plane characteristics, are less mechanically demanding and fulfill the requirements of many users.

As the person skilled in the art will also appreciate that embodiments shown in the drawings are independent of the generation principle and thus are valid for not only electro-hydraulic shock wave generation but also for, but not limited to, PP/SW generation based on electromagnetic, piezoceramic and ballistic principles. The pressure pulse generators may, in certain embodiments, be equipped with a water cushion that houses water which defines the path of pressure pulse waves that is, through which those waves are transmitted. In a preferred embodiment, a patient is coupled via ultrasound gel or oil to the acoustic exit window (17), which can, for example, be an acoustic transparent membrane, a water cushion, a plastic plate or a metal plate.

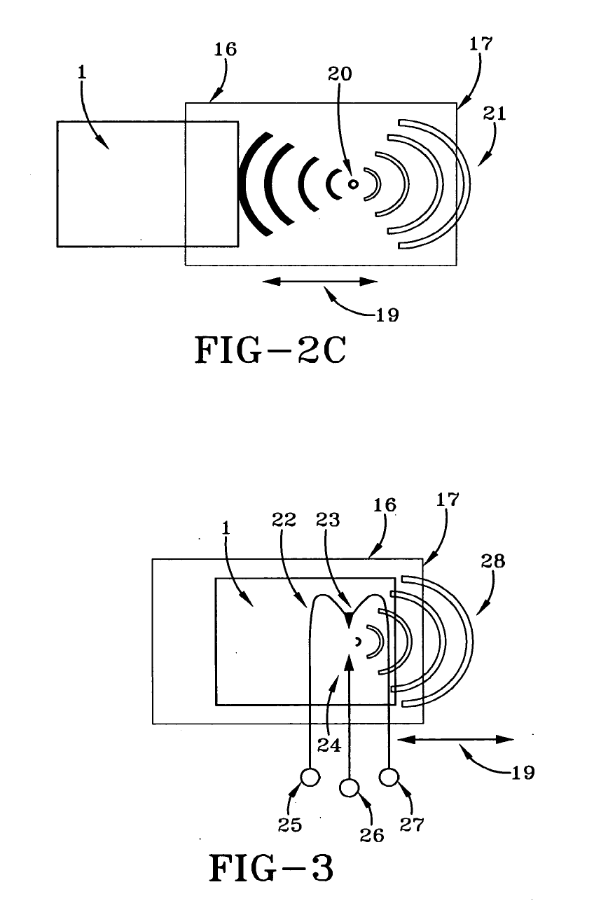

FIG. 3 is a simplified depiction of the pressure pulse/shock wave apparatus having no focusing reflector or other focusing element. The generated waves emanate from the apparatus without coming into contact with any focusing elements. FIG. 3 shows, as an example, an electrode as a pressure pulse generating element producing divergent waves (28) behind the ignition point defined by a spark between the tips of the electrode (23, 24).

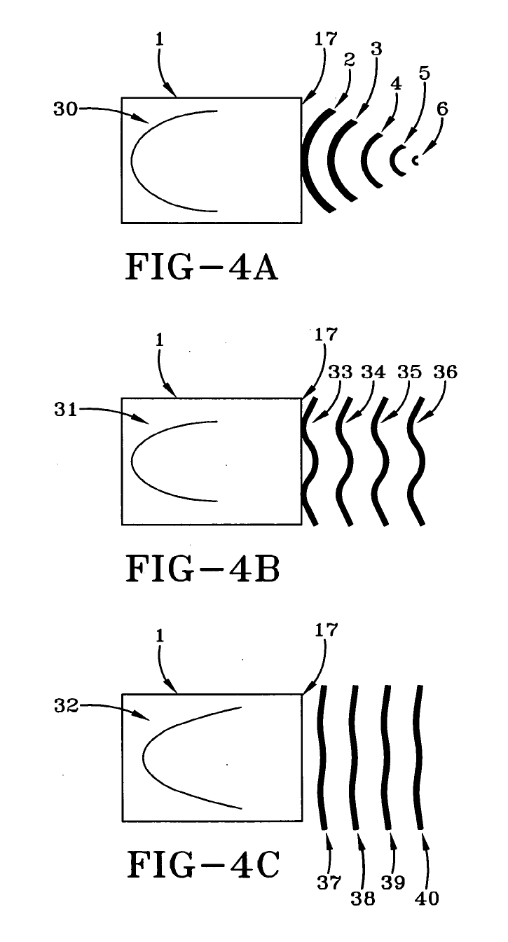

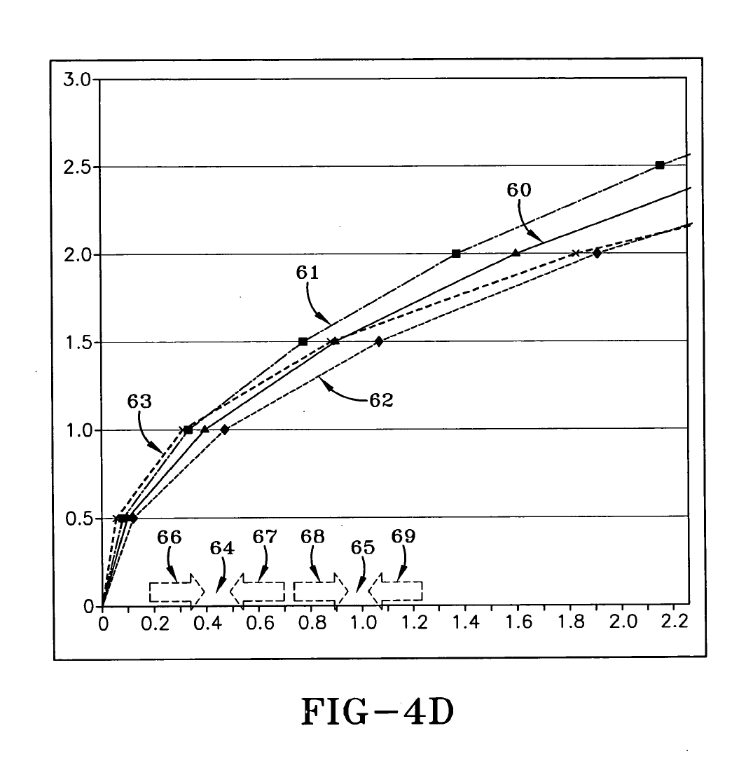

FIG. 4a is a simplified depiction of the pressure pulse/shock wave generator (shock wave head) having as focusing element an ellipsoid (30). Thus, the generated waves are focused at (6).

FIG. 4b is a simplified depiction of the pressure pulse/shock wave generator (shock wave head) having as a focusing element an paraboloid (y²=2px). Thus, the characteristics of the wave fronts generated behind the exit window (33, 34, 35, and 36) are disturbed plane (“parallel”), the disturbance resulting from phenomena ranging from electrode burn down, spark ignition spatial variation to diffraction effects. However, other phenomena might contribute to the disturbance.

FIG. 4c is a simplified depiction of the pressure pulse/shock wave generator (shock wave head) having as a focusing element a generalized paraboloid (yⁿ=2px, with 1.2<n<2.8 and n≠2). Thus, the characteristics of the wave fronts generated behind the exit window (37, 38, 39, and 40) are, compared to the wave fronts generated by a paraboloid (y²=2px), less disturbed, that is, nearly plane (or nearly parallel or nearly even (37, 38, 39, 40)). Thus, conformational adjustments of a regular paraboloid (y²=2px) to produce a generalized paraboloid can compensate for disturbances from, e.g., electrode burn down. Thus, in a generalized paraboloid, the characteristics of the wave front may be nearly plane due to its ability to compensate for phenomena including, but not limited to, burn down of the tips of the electrode and/or for disturbances caused by diffraction at the aperture of the paraboloid. For example, in a regular paraboloid (y²=2px) with p=1.25, introduction of a new electrode may result in p being about 1.05. If an electrode is used that adjusts itself to maintain the distance between the electrode tips (“adjustable electrode”) and assuming that the electrodes burn down is 4 mm (z=4 mm), p will increase to about 1.45. To compensate for this burn down, and here the change of p, and to generate nearly plane wave fronts over the life span of an electrode, a generalized paraboloid having, for example n=1.66 or n=2.5 may be used. An adjustable electrode is, for example, disclosed in U.S. Pat. No. 6,217,531.

FIG. 4d shows sectional views of a number of paraboloids. Numeral 62 indicates a paraboloid of the shape y²=2px with p=0.9 as indicated by numeral 64 at the x axis which specifies the p/2 value (focal point of the paraboloid). Two electrode tips of a new electrode 66 (inner tip) and 67 (outer tip) are also shown in the Figure. If the electrodes are fired and the tips are burning down the position of the tips change, for example, to position 68 and 69 when using an electrode which adjusts its position to compensate for the tip burn down. In order to generate pressure pulse/shock waves having nearly plane characteristics, the paraboloid has to be corrected in its p value. The p value for the burned down electrode is indicate by 65 as p/2=1. This value, which constitutes a slight exaggeration, was chosen to allow for an easier interpretation of the Figure. The corresponding paraboloid has the shape indicated by 61, which is wider than paraboloid 62 because the value of p is increased. An average paraboloid is indicated by numeral 60 in which p=1.25 cm. A generalized paraboloid is indicated by dashed line 63 and constitutes a paraboloid having a shape between paraboloids 61 and 62. This particular generalized paraboloid was generated by choosing a value of n≠2 and a p value of about 1.55 cm. The generalized paraboloid compensates for different p values that result from the electrode burn down and/or adjustment of the electrode tips.

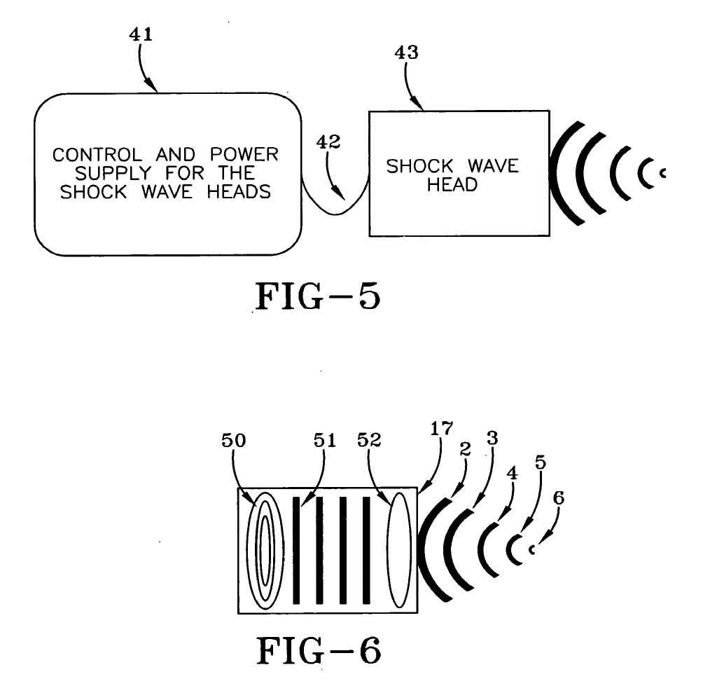

FIG. 5 is a simplified depiction of a set-up of the pressure pulse/shock wave generator (43) (shock wave head) and a control and power supply unit (41) for the shock wave head (43) connected via electrical cables (42) which may also include water hoses that can be used in the context of the present invention. However, as the person skilled in the art will appreciate, other set-ups are possible and within the scope of the present invention.

FIG. 6 is a simplified depiction of the pressure pulse/shock wave generator (shock wave head) having an electromagnetic flat coil 50 as the generating element. Because of the plane surface of the accelerated metal membrane of this pressure pulse/shock wave generating element, it emits nearly plane waves which are indicated by lines 51. In shock wave heads, an acoustic lens 52 is generally used to focus these waves. The shape of the lens might vary according to the sound velocity of the material it is made of. At the exit window 17 the focused waves emanate from the housing and converge towards focal point 6.

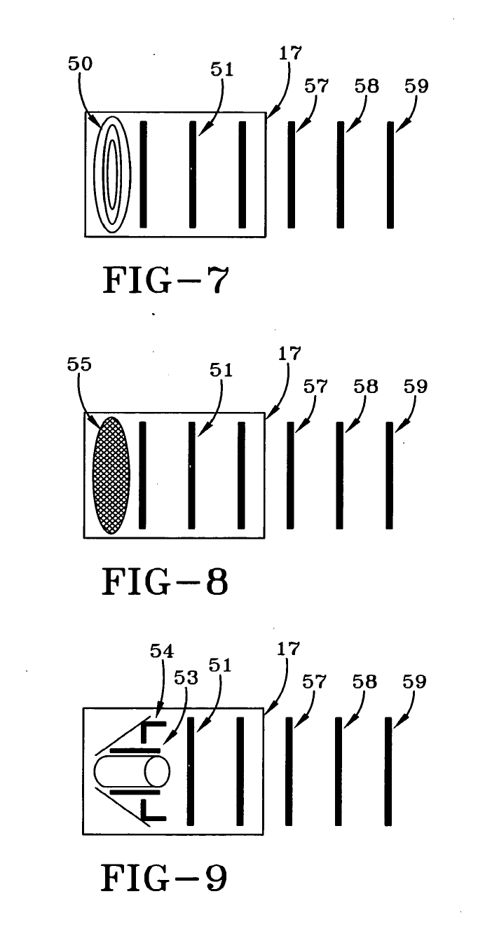

FIG. 7 is a simplified depiction of the pressure pulse/shock wave generator (shock wave head) having an electromagnetic flat coil 50 as the generating element. Because of the plane surface of the accelerated metal membrane of this generating element, it emits nearly plane waves which are indicated by lines 51. No focusing lens or reflecting lens is used to modify the characteristics of the wave fronts of these waves, thus nearly plane waves having nearly plane characteristics are leaving the housing at exit window 17.

FIG. 8 is a simplified depiction of the pressure pulse/shock wave generator (shock wave head) having an piezoceramic flat surface with piezo crystals 55 as the generating element. Because of the plane surface of this generating element, it emits nearly plane waves which are indicated by lines 51. No focusing lens or reflecting lens is used to modify the characteristics of the wave fronts of these waves, thus nearly plane waves are leaving the housing at exit window 17. Emitting surfaces having other shapes might be used, in particular curved emitting surfaces such as those shown in FIGS. 4a to 4c as well as spherical surfaces. To generate waves having nearly plane or divergent characteristics, additional reflecting elements or lenses might be used. The crystals might, alternatively, be stimulated via an electronic control circuit at different times, so that waves having plane or divergent wave characteristics can be formed even without additional reflecting elements or lenses.

FIG. 9 is a simplified depiction of the pressure pulse/shock wave generator (shock wave head) comprising a cylindrical electromagnet as a generating element 53 and a first reflector having a triangular shape to generate nearly plane waves 54 and 51. Other shapes of the reflector or additional lenses might be used to generate divergent waves as well.

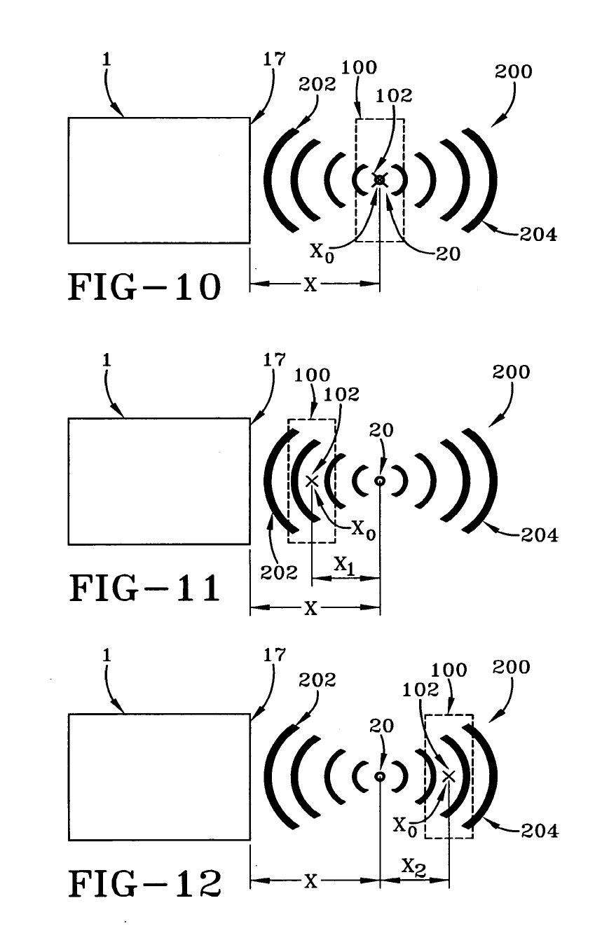

With reference to FIGS. 10, 11 and 12 a schematic view of a shock wave generator or source 1 is shown emitting a shock wave front 200 from an exit window 17. The shock wave front 200 has converging waves 202 extending to a focal point or focal geometric volume 20 at a location spaced a distance X from the generator or source 1. Thereafter the wave front 200 passes from the focal point or geometric volume 20 in a diverging wave pattern as has been discussed in the various other FIGS. 1-9 generally.

With particular reference to FIG. 10 an organ 100 is shown generally centered on the focal point or volume 20 at a location X₀ within the organ 100. In this orientation the emitted waves are focused and thus are emitting a high intensity acoustic energy at the location X₀. This location X₀ can be anywhere within or on the organ. Assuming the organ 100 is a tissue having a mass 102 at location X₀ then the focus is located directly on the mass 102. In one method of treating a tumor or any other type mass 102 these focused waves can be directed to destroy or otherwise reduce the mass 102.

With reference to FIG. 11, the organ 100 is shifted a distance X toward the generator or source 1. The organ 100 at location X₀ being positioned a distance X-X from the source 1. This insures the organ 100 is impinged by converging waves 202 but removed from the focal point 20. When the organ 100 is tissue this bombardment of converging waves 202 stimulates the cells activating the desired healing response as previously discussed.

With reference to FIG. 12, the organ 100 is shown shifted or located in the diverging wave portion 204 of the wave front 200. As shown X₀ is now at a distance X₂ from the focal point or geometric volume 20 located at a distance X from the source 1. Accordingly X₀ is located a distance X+X₂ from the source 1. As in FIG. 10 this region of diverging waves 204 can be used to stimulate the organ 100 which when the organ is a cellular tissue stimulates the cells to produce the desired healing effect or response, in the case of the testicles in the scrotum to increase testosterone production.

Heretofore such invasive techniques were not used in combination with shock wave therapy primarily because the shock waves were believed to be able to sufficiently pass through interfering body tissue to achieve the desired result in a non-invasive fashion. While this may be true, in many cases if the degenerative process is such that an operation is required then the combination of an operation in conjunction with shock wave therapy only enhances the therapeutic values and the healing process of the patient and the organ such that regenerative conditions can be achieved that would include not only revascularization of the heart or the reproductive organs wherein sufficient or insufficient blood flow is occurring but also to enhance the improvement of ischemic tissue that may be occupying a portion of the organ. This ischemic tissue can then be minimized by the regenerative process of using shock wave therapy in the fashion described above to permit the tissue to rebuild itself in the region that has been afflicted.

As shown in FIGS. 1-12 the use of these various acoustic shock wave forms can be used separately or in combination to achieve the desired therapeutic effect.

Furthermore such acoustic shock wave forms can be used in combination with drugs, chemical treatments, irradiation therapy or even physical therapy and when so combined the stimulated cells will more rapidly assist the body's natural healing response.

The present invention provides an apparatus for an effective treatment of indications, which benefit from low energy pressure pulse/shock waves having planar, nearly plane, convergent or even divergent characteristics. With an unfocused wave having planar, nearly plane wave characteristic, convergent or even divergent wave characteristics, the energy density of the wave may be or may be adjusted to be so low that side effects including pain are very minor or even do not exist at all.

In certain embodiments, the apparatus of the present invention is able to produce waves having energy density values that are below 0.1 mJ/mm2 or even as low as 0.000 001 mJ/mm2 In a preferred embodiment, those low end values range between 0.1-0.001 mJ/mm2 With these low energy densities, side effects are reduced and the dose application is much more uniform. Additionally, the possibility of harming surface tissue is reduced when using an apparatus of the present invention that generates waves having planar, nearly plane, convergent or divergent characteristics and larger transmission areas compared to apparatuses using a target focused shock wave source that needs to be moved around to cover the affected target area. The apparatus of the present invention also may allow the user to make more precise energy density adjustments than an apparatus generating only focused shock waves, which is generally limited in terms of lowering the energy output.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. The method of treatment for increasing testosterone levels in an adult male patient comprises the steps of:
activating an acoustic shock wave generator or source to emit acoustic shock waves; and
subjecting a testicle through the scrotum to the acoustic shock waves stimulating said testicle wherein the testicle is positioned within a path of the emitted shock waves.

2. The method of treatment of claim 1 wherein the emitted shock waves are convergent, divergent, planar or near planar.

3. The method of treatment of claim 1 wherein the emitted shock waves are convergent having one or more geometric focal volumes of points at a distance of at least X from the generator or source, the method further comprising positioning the organ at a distance at or less than the distance X from the source.

4. The method of treatment of claim 1 further comprises the step of:
testing the testosterone level of the patient prior to treatment.

5. The method of treatment of claim 1 further comprises the step of:
testing the testosterone level of the patient after exposure to one or more acoustic shock wave treatments within 72 hours post treatment.
